(19) United States
(12) Patent Application Publication
(10) Pub. No.: US 2008/0062303 A1
(43) Pub. Date: Mar. 13, 2008

(54) Mobile communication device and base or holder therefor

(76) Inventor: Anthony Dixon, Shipley (GB)

Correspondence Address: HEAD, JOHNSON & KACHIGIAN, 228 W 17TH PLACE, TULSA, OK, 74119, US

(21) Appl. No.: 11/518,715

(22) Filed: Sep. 11, 2006

(51) Int. Cl. H04N 5/225

(52) U.S. Cl. 348/373

(57) ABSTRACT

The invention relates to apparatus including a communications device such as a mobile telephone or P.D.A which is capable of receiving and transmitting data and of capturing video images. The device can be located on a movable means of a holder, so as to be movable to allow the angle or rotational position of the device to be adjusted with respect to the remainder of the holder. This allows the communication device to be positioned as required and relay video image data to a remote location to allow a monitoring facility to be provided.

### CROSS-REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

This invention relates to a mobile communication device such as, but not exclusively, a mobile telephone or PDA, which device is provided with a viewing means incorporating a camera lens for the taking of photographs and/or video. The invention further relates to the provision of a base or holder for the reception of the device and to a means of utilization of the device and the holder in conjunction, to provide a beneficial effect to a user of the device.

The provision of communication devices such as mobile telephones or PDA's is well known, and it is increasingly the case that most members of the general public own or hire at least one device. While many of the devices are kept on or about a person at most times, the devices are required to be charged from time to time. The charging typically occurs by connection of the device to a main electricity supply. At these times, the device is typically provided in a stationary location in a premises. Furthermore, communication devices which are owned by the elderly or children, in particular, are often found not to be used for prolonged periods of time and, therefore, are again kept at a stationary location in a premises.

Many devices are now provided with a viewing means in the form of a camera that allows digital photographs and/or portions of video to be taken and then be viewable immediately via a screen on the communication device and/or stored in a memory in the device or transferred from the device to a remote viewing means.

The aim of the present invention is to utilize the viewing means, which typically comprise a digital data memory linked to a viewing lens, to be utilized even when the device is not necessarily carried by the person who owns the same.

In a first aspect of the invention there is provided image capturing apparatus. The apparatus includes a communication device having at least one lens connected to means for processing data into a viewable image or video images, a holder for a selective location of the device thereon, and wherein the holder incorporates movement means such that the position of the device can be selectively adjusted so as to allow images captured by the communication device to be controlled. In one embodiment, the movement means incorporates a motor mounted to cause movement of a portion of the holder on which the device can be located.

Typically, the holder is connected to a power supply and/or may be provided with batteries so as to allow the motor and the movement means to be powered.

In one embodiment, the power supply can also be used to charge the device when it is located on the holder. The power supply can also be used to power the device, if required.

In one embodiment, the communication device has the ability to transmit and/or receive signals to and/or from a remote location, such as another mobile phone or similar communication device, and thereby allow data representative of the captured images to be transmitted to the remote location.

In one embodiment, the holder is provided with a means to receive signals either directly from a device at a remote location device or, alternatively, via the communication device located on the base. The signals are used to control movement of the movement means of the holder and, hence, the device.

In one embodiment, the device holder includes a speaker via which data received from the device itself, or received by the device from a remote location, can be generated as audio.

Typically, an angle of the device with respect to the holder can be adjusted and/or the rotational position of the device with respect to the holder can be adjusted by control of the movement means. Preferably, movement of the movement means is possible about two axes.

In one embodiment, the device is controlled such that the viewing means takes a series of images at selected time intervals and the images are transmitted to the remote location for viewing.

Alternatively, the device is set such that the viewing means takes a series of continuous images. In either embodiment the data can be transmitted to a remote location.

In one embodiment, the device or holder includes a microphone and data captured via the microphone can be transmitted.

Yet further and alternatively, the device is inactive until a change in condition is detected in the environment around the device such as, for example, the occurrence of a noise, switching on of a light, detection of smoke or the like whereupon the viewing means is activated

The communications used between the device and the base can be wire or wireless connection, such as Bluetooth or similar systems.

In one embodiment, the apparatus includes a communication device, a holder for the device, movement means to allow the device to be moved with respect to at least part of the holder. The apparatus includes data transmission and receiving means, and an image capturing lens. The apparatus receives data that is relayed to the movement means to allow control of the device movement and transmits data indicative of the video images captured by the device.

In one embodiment, the remote location is another communication device.

### BRIEF DESCRIPTION OF THE SEVERAL VIEWS OF THE DRAWINGS

Specific embodiments of the invention are now described with reference to the accompanying drawings.

FIG. 1 illustrates in schematic manner an embodiment of the invention.

FIG. 2 illustrates in plan the possibility of movement of the communication device with respect to a base.

### DETAILED DESCRIPTION OF THE INVENTION

Referring now to the figures, there is illustrated a communication device 2 in use, in accordance with the invention, in combination with a holder 4. The holder 4 is connected to a power supply 6 and includes a movement means portion 8 having a location formation 10 formed therein for the reception of the communication device. The communication device, in this embodiment, is in the form of a mobile phone having a display screen 14, keys 16, a viewing camera lens 18 and speaker 19.

In this embodiment, the portion to which the device is located at the holder also has electrical connections so as to, first, allow the power supply to be provided to communication device 2 and also for a charging facility to be provided as part of the holder, such that when the device is positioned on the holder, the battery in the same can be charged.

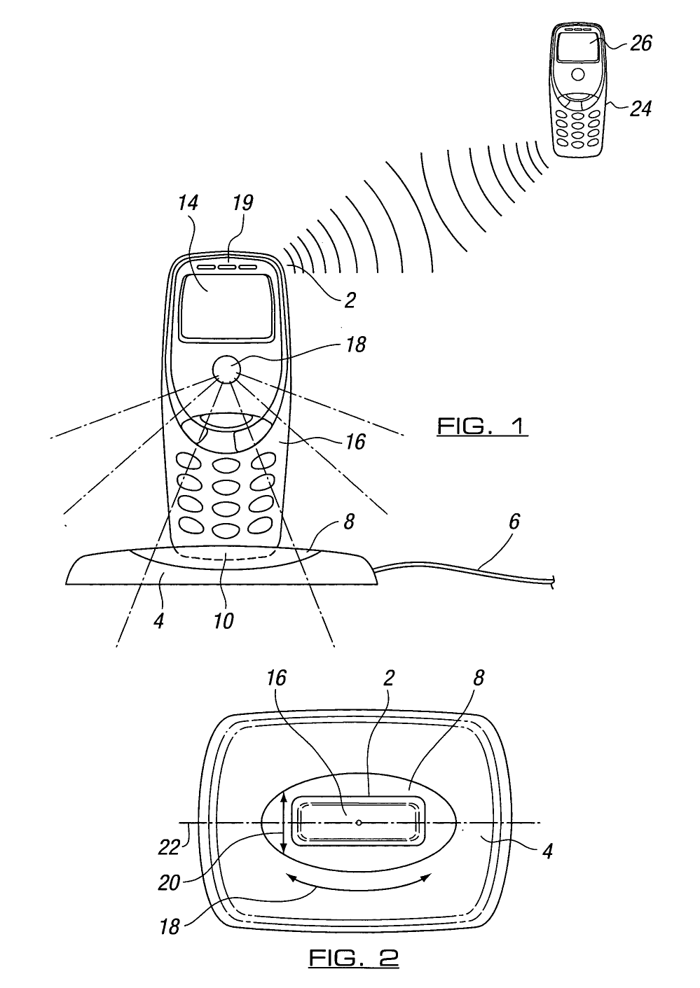

The camera lens 18 on the communication device is provided to be active and acts as a means for viewing the environment surrounding holder 4. The images captured by camera lens 18 can then be transmitted from device 2 via a suitable communication means, such as a mobile telephone network, to a further communication device 24 (shown here in FIG. 1 but typically geographically separated from device 2). The received data is then used to display the captured images from device 2 on a display screen 26 of device 24 such that the user of device 24 can then be aware of what is happening in the environment surrounding communication device 2.

Remotely located device 24 can also be used as a control means for controlling the orientation and angle of movable portion 8 of holder 4 and hence device 2 by the user dialing from his/her device 24 to connect to communication device 2 held on holder 4. A link between communication device 2 and the control means for movable portion 8 of the holder is used to cause movement of holder portion 8 as a result of the directions received from device 24 either by voice or tone sequences. Hence, communication device 2 can be controlled, as shown in FIG. 2, to move about axis 16, typically through 360° as indicated by the arrow 18, and/or the angular orientation of the portion 8 and device 2 can be adjusted as indicated by the arrow 20 about axis 22. As a result, camera lens 18 on communication device 2 is effectively moved and can scan throughout the surrounding environment.

It is envisaged that there are many practical implementations of this invention, such as the apparatus can be used to provide a monitoring facility in, for example, a room in which a baby or child is sleeping. This means that device 2 is in the child's room and the parents, by carrying the remote device 24, can leave the baby in the room whilst ensuring that the baby is continuing to be monitored via camera lens 18 of device 2 and the communication network connection to device 24. Furthermore, this could be used for monitoring of an environment of old age pensioners, ill persons, for security purposes, a video phone system or the like.

If required, the holder or device can also include a microphone system so as to detect any sounds which may occur in the surrounding environment and can include a speaker so as to allow the person or persons at the remote location to communicate with the base via the communication device 2 mounted on the same and speak to a person within the environment.

1. Image capturing apparatus, said apparatus comprising:
a communication device having at least one lens connected to means for processing data into a viewable image or video images; and
a holder for a selective location of the device thereon and the holder incorporates movement means such that the position of the device can be selectively adjusted so as to allow images captured by the communication device to be controlled.

2. Apparatus according to claim 1 wherein said movement means incorporates a motor mounted to cause movement of a portion of said holder on which said communication device can be located.

3. Apparatus according to claim 1 wherein said apparatus includes control means for said movement means to allow images captured by said communication device to be selectively controlled by movement of said device.

4. Apparatus according to claim 3 wherein said control means for said communication device allow zooming in or out of said at least one lens.

5. Apparatus according to claim 3 wherein said control means allow selection of captured or still or moving pictures.

6. Apparatus according to claim 1 wherein said holder is connected to a power supply so as to provide power to said movement means.

7. Apparatus according to claim 6 wherein said power supply is connected to said communication device.

8. Apparatus according to claim 1 wherein said communication device can transmit and receive signals to and from a device at a remote location.

9. Apparatus according to claim 1 wherein said holder is provided with a data receiving means to receive signals from a device at a remote location.

10. Apparatus according to claim 1 wherein said holder is provided with a data receiving means to receive signals from the device mounted thereon.

11. Apparatus according to claim 9 wherein the received signals are used to control movement of said movement means of said holder.

12. Apparatus according to claim 1 wherein an angle of said communication device with respect to said holder can be adjusted.

13. Apparatus according to claim 1 wherein a rotational position of said communication device with respect to said holder can be adjusted.

14. Apparatus according to claim 1 wherein movement of said movement means of said holder and said device is possible about two axes.

15. Apparatus according to claim 1 wherein said communication device is controlled such that viewing means takes a series of images at selected time intervals and the images are transmitted to a remote location for viewing.

16. Apparatus according to claim 1 wherein said communication device is controlled such that viewing means takes a series of continuous images.

17. Apparatus according to claim 1 wherein said communication device is inactive until a change in condition is detected in an environment surrounding said communication device.

18. Apparatus according to claim 17 wherein the change in condition is any or any combination of occurrence of a noise, switching on of a light, detection of smoke, detection of movement.

19. Apparatus according to claim 1 wherein communication between said device and said holder is by wire.

20. Apparatus according to claim 1 wherein communication between said device and said base is by wireless connection.

21. Apparatus according to claim 1 wherein said apparatus includes a speaker to allow audio to be generated.

22. Apparatus according to claim 1 wherein said apparatus includes data receiving and transmission means, said apparatus receiving data signals which are relayed to said movement means to allow control of said device movement and transmits data signals which are indicative of the video images captured by said device.

23. Apparatus according to claim 10 wherein the received signals are used to control movement of said movement means of said holder.
